(19) United States
(12) Patent Application Publication
(10) Pub. No.: US 2026/0323616 A1
(43) Pub. Date: Oct. 15, 2026

(54) DYNAMIC BANDWIDTH EXTENSION OPERATION

(71) Applicant: NXP USA, Inc., AUSTIN, TX (US)

(72) Inventors: Liwen Chu, San Ramon, CA (US); Huizhao Wang, San Jose, CA (US); Hongyuan Zhang, Fremont, CA (US)

(21) Appl. No.: 19/640,781

(22) Filed: Apr. 7, 2026

Related U.S. Application Data
(60) Provisional application No. 63/785,909, filed on Apr. 9, 2025.

(51) Int. Cl. H04W 72/0453; H04L 1/00; H04L 1/1607; H04W 84/12

(52) U.S. Cl. CPC H04W 72/0453; H04L 1/0068; H04L 1/1614; H04W 84/12

(57) ABSTRACT

Performing dynamic bandwidth extension (DBE) between an access point (AP) and a station (STA) operating in accordance with Institute of Electrical and Electronics Engineers (IEEE) 802.11bn comprises: transmitting, by the AP, a frame which indicates that the AP is enabling DBE operation, the frame further defining DBE information associated with when the DBE operation is enabled; receiving, by the station, the frame; transmitting, by the station, a request to the AP to enable the DBE operation on the station; receiving, by the AP, the request; determining, by the AP, whether to accept the request to enable the DBE operation by the station; and transmitting, by the AP, a response to the request of whether to enable the DBE operation.

### CROSS-REFERENCE TO RELATED APPLICATIONS

This application claims the benefit under 35 U.S.C. § 119 of U.S. Provisional Patent Application Ser. No. 63/785,909 titled “DYNAMIC BANDWIDTH EXTENSION” filed Apr. 9, 2025, the contents of which are incorporated herein by reference in its entirety.

### FIELD OF USE

The present disclosure relates generally to wireless communication over a frequency spectrum, and more particularly, to a system, method, and apparatus for dynamic bandwidth extension operation compatible with Institute of Electrical and Electronics Engineers (IEEE) 802.11bn (WiFi).

### BACKGROUND

A basic service set (BSS) operating channel with a BSS operating bandwidth defines frequencies used by an access point (AP) and associated stations to wirelessly communicate with each other. An AP operating in accordance with an ultra high reliability (UHR) protocol defined by IEEE 802.11bn supports a Dynamic bandwidth extension (DBE) capability to dynamically expand an AP operating channel and bandwidth corresponding to the BSS operating channel with BSS operating bandwidth to a DBE operating channel with a DBE operating bandwidth. The AP enables DBE operation and uses the expanded channel and bandwidth in an announced time period defined by a start time to communicate with associated stations that also enable DBE operation.

### BRIEF DESCRIPTION OF THE DRAWINGS

The following detailed description of the preferred embodiments of the present disclosure will be better understood when read in conjunction with the appended drawings. The present disclosure is illustrated by way of example, and not limited by the accompanying figures, in which like references indicate similar elements.

FIG. 1 illustrates an example block diagram of a communication system in accordance with one or more embodiments.

FIG. 2 illustrates example operating channels and enabling a non-primary channel access (NPCA) not covered by a basic service set (BSS) operating channel when dynamic bandwidth extension (DBE) operation is enabled by an access point (AP) in accordance with one or more embodiments.

FIG. 3 illustrates example fields of a critical update element carrying DBE information with one or more embodiments.

FIG. 4 illustrates another example fields of a critical update element carrying DBE information in accordance with one or more embodiments.

FIG. 5 illustrates an example negotiation between a station and AP to enable the DBE operation by the station and the AP in accordance with one or more embodiments.

FIG. 6 illustrates another example negotiation between the station and the AP to enable the DBE operation by the station and the AP in accordance with one or more embodiments.

FIG. 7 illustrates an example of an action field in a UHR request frame and UHR response frame associated with the negotiation of DBE operation by the AP and station in accordance with one or more embodiments.

FIG. 8 is an example flow chart of functions associated with dynamic bandwidth extension (DBE) configuration of the AP and the station in accordance with one or more embodiments.

### DETAILED DESCRIPTION

The detailed description of the appended drawings is intended as a description of the currently preferred embodiments of the present disclosure, and is not intended to represent the only form in which the present disclosure may be practiced. It is to be understood that the same or equivalent functions may be accomplished by different embodiments that are intended to be encompassed within the spirit and scope of the present disclosure.

Embodiments disclosed herein are directed to method, systems, and apparatus for enabling and disabling a dynamic bandwidth extension (DBE) operation to facilitate wireless communication between an access point (AP) and a station (STA). The DBE operation is enabled by one or more of a capabilities element, an operation element, or a critical update element carried in a beacon transmitted by the AP and a negotiation between the AP and the station. Well known instructions, protocols, structures, and techniques have not been shown in detail in order not to obfuscate the description.

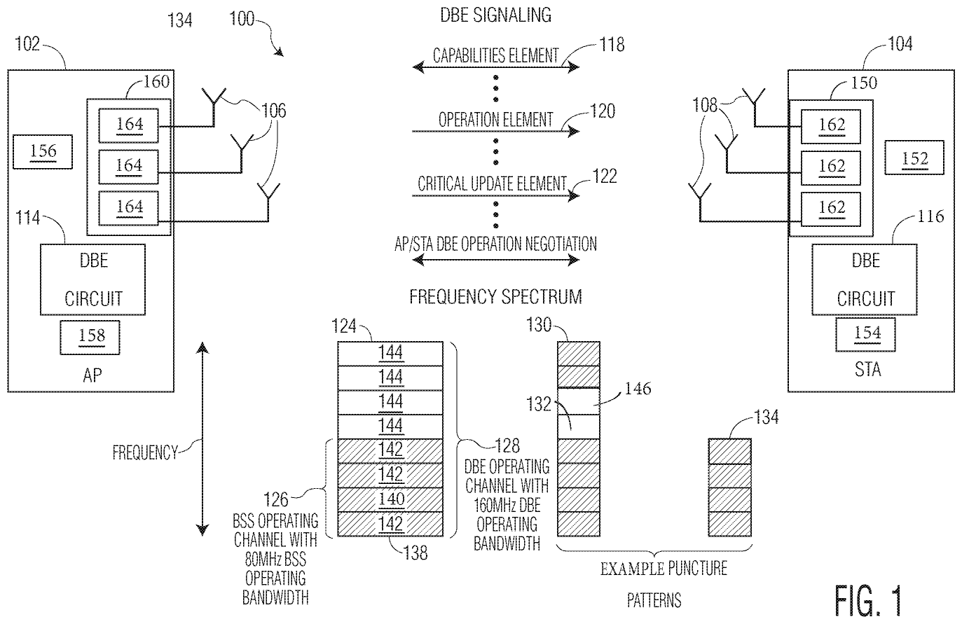

FIG. 1 illustrates an example block diagram of a communication system 100 in accordance with one or more embodiments. The communication system 100 may include an access point (AP) 102 and a station 104 that are compliant with Institute of Electrical and Electronics Engineers (IEEE) 802.11bn (“Ultra High Reliability” or UHR). The AP 102 may be a networking device which facilitates connecting the station 104 to a wired network (not shown) via a wireless connection between the AP 102 and station 104. In an embodiment, the station 104 is a fixed or mobile wireless terminal such as a smart phone, laptop, and internet of things (IOT) device. The AP 102 and station 104 and functions described herein may be implemented by one or more of analog circuitry, mix signal circuitry, memory circuitry, logic circuitry, and processing circuitry that executes code stored in a memory to perform disclosed functions on one or more integrated circuits.

In one or more embodiments, the station 104 may be operable in a frequency band, such as a 5 GHz, 6GHz, or 2.4 GHz band, and have one or more antenna 108 for transmitting or receiving WiFi signals in the band. The station 104 may further have a host processor 154 which enables the station 104 to transmit and receive signals as described herein. A network interface includes a medium access control (MAC) processing unit 152 and a physical layer (PHY) processing unit 150. The PHY processing unit 150 includes a plurality of transceivers 162 (e.g., transmitters and/or receivers) and the transceivers 162 are coupled to a respective antenna 108 for transmitting or receiving wireless signals. Although three transceivers and three antennas are illustrated, the station 104 includes other suitable numbers (e.g., 1, 2, 4, 5, etc.) of transceivers and antennas in other embodiments. In one or more embodiments, the MAC processing unit 152 and the PHY processing unit 150 are configured to operate according to a communication protocol such as Institute of Electrical and Electronics Engineers (IEEE) 802.11bn WiFi standard. The AP 102 may have similar structure and components including a respective processor 158 and network interface including a MAC processing unit 156, PHY processing unit 160 and plurality of transceivers 164 coupled to a respective antenna 106 for transmitting or receiving wireless signals. The station 104 may be associated with the AP 102 based on an association process defined by IEEE 802.11bn after the AP 102 successfully authenticates the station 104 and establishes a communication link with the station 104. Further, the AP 102 may associate with more than one station 104 and the illustration of one station 104 which the AP 102 is associated is illustrated as an example.

The AP 102 and station 104 may transmit and receive signals between each other over a frequency spectrum having a plurality of channels. A basic service set (BSS) operating channel 126 defines a plurality of channels used by the access point (AP) 102 and associated stations 104 to communicate. Each channel, an example of which is channel 138, may be a 20 MHz channel. The BSS operating channel 126 has a BSS operating bandwidth which refers to a range of frequencies used by the AP 102 and associated stations 104 to transmit data. It defines how much of the frequency spectrum is used for communication, directly impacting a maximum data rate for communication between the AP 102 and associated stations 104, with wider channels providing higher speed but potentially more interference. In an embodiment shown, the BSS operating channel 126 may have 4 channels which are each 20 MHz with a BSS operating bandwidth of 80 MHz but the BSS operating channel 126 may take different forms for different BSS operating bandwidth such as 40 MHz, 160 MHz and 320 MHz bandwidths.

In one or more embodiments, the BSS operating channel 126 may have a primary channel and one or more secondary channels. Channel 140 is an example primary channel and channels 142 are example secondary channel of the BSS operating channel 126. The primary channel 140 may be a 20 MHz band used for communication of management and control frames while the secondary channels 142 may be one or more adjacent 20 MHz channels paired with the primary channel 140 to increase a BSS operating bandwidth to 40, 80, 160 MHz, 320 MHz etc. between the AP 102 and station 104 for higher data throughput in conjunction with the primary channel 140. In some embodiments, some of the secondary channels 142 in the BSS operating bandwidth may not be used because they have interference. A BSS static channel puncture pattern may identify 0, 1 or more 20 MHz channel being punctured (punctured channel) in line with one of a non-OFDMA puncture pattern which identifies channels not to be used in the BSS operating bandwidth. For example, BSS static channel puncture pattern 134 may indicate that no channel is punctured in the BSS operating channel 126.

An access point (AP) 102 operating in accordance with an ultra high reliability (UHR) protocol defined by IEEE 802.11bn may support a Dynamic bandwidth extension (DBE) capability to dynamically extend an AP operating channel and AP operating bandwidth corresponding to the BSS operating channel and BSS operating bandwidth to a DBE operating channel 128 with an DBE operating bandwidth for UHR stations that also support DBE operation. The DBE operating channel 128 may have a plurality of channels greater than the BSS operating channel 126. In an embodiment shown, the DBE operating channel 128 may include 8 channels with a DBE operating bandwidth of 160 MHz but could include more or less channels in other embodiments. The punctured 20 MHz channel(s) covered by the DBE operating channel but not covered by the BSS operating channel and the punctured channels, if exists, only covered by the BSS operating channel define a DBE static channel puncture pattern and is one of the non-OFDMA channel puncture pattern related to the DBE operating bandwidth. If a channel covered by BSS operating channel is not punctured in BSS static channel puncture pattern, the channel is not punctured in DBE static channel puncture pattern. In one or more embodiments, the DBE operating channel 128 may include the BSS primary channel and one or more secondary channels. Further, one or more secondary channels 144 and the punctured channels, if exists, covered by the BSS operating bandwidth may be punctured based on a non-OFDMA puncture pattern related to the DBE operating bandwidth. For example, a DBE static channel puncture pattern 130 of the DBE operating channel 128 illustrates that a secondary channel 132 and another secondary channel 146 which are covered by the DBE operating channel 128 and not covered by BSS operating channel 126 may be punctured.

The AP 102 announces its DBE capability, e.g., the DBE operating channel 128, DBE operating bandwidth and DBE static channel puncture pattern. In one or more embodiments, the DBE operating bandwidth may be a narrower bandwidth than a bandwidth capability of the AP 102. In an embodiment, the AP 102 that enables DBE is not allowed to change its AP operating bandwidth through a method other than by a DBE update procedure as described in more detail below. In an embodiment, the AP 102 operating bandwidth is the same as the DBE operating bandwidth. In one or more embodiments, an operation mode notification (OMN) frame or operating mode control (OMC) field carried in a beacon transmitted by the AP 102 and which is conventionally used to change an operating bandwidth of the AP 102 may not be used to indicate the DBE operating channel 128 and DBE operating bandwidth. An Operating Mode Notification (OMN) frame is an 802.11ac/ax management action frame transmitted by the AP 102 to dynamically inform the station 104 of changes to its operating bandwidth. In an embodiment, if the AP 102 is in a dynamic power save (DPS) mode, the AP 102 may announce its operating bandwidth and a number of spatial streams, respectively, and is the same as the operating bandwidth and Nss of the AP's low capability (LC) mode which is a reduced bandwidth mode to conserve power. In one or more embodiments, an operation mode notification (OMN) frame or operating mode control (OMC) field may be used to update the DBE operating channel 128 and the DBE operating bandwidth.

Embodiments disclosed herein are directed to announcing a DBE capability and enabling and disabling a dynamic bandwidth extension (DBE) operation to facilitate wireless communication between an access point (AP) and a station (STA). The AP 102 and station 104 may have a respective DBE circuit and functionality 114, 116 to facilitate transmission of DBE information (e.g., indication of one or more of announcing DBE capability, enabling DBE operation, DBE operating channel, DBE operating bandwidth, DBE static channel puncture pattern) to enable, update or disable the DBE operation and in some embodiments indicate DBE static channel puncture pattern by using a DBE punctured subchannel bitmap. The announcement procedure may include the AP 102 or station 104 transmitting a UHR capabilities element 118 in a management frame such as an action frame. In the UHR capabilities element 118, a one-bit DBE Supported field is used to indicate whether the AP 102 or station 104 carrying the field supports the DBE operation. The AP 102 may also transmit a UHR operation element 120 that carries DBE information to indicate whether the AP 102 enables the DBE operation. The UHR operation element 120 may be included in a management frame such as a beacon and a one-bit DBE Enabling field indicates whether the AP enables its DBE. In an embodiment, the DBE information also may include a 2-bit or 3-bit DBE operating bandwidth indication and 2-octet DBE static channel puncture pattern carried in the UHR Operation element. The two or three bit operating bandwidth indication indicates a bandwidth of the DBE operating channel 128 and the DBE static channel puncture pattern indicates the punctured 20 MHz channel(s) in the DBE operating bandwidth if the DBE Enabling field indicates the enabling of DBE. In some embodiments, the UHR operation element is transmitted in an association response to an association request in the association process defined by IEEE 802.11 between the AP 102 and station 104. If the DBE Enabling field indicates the enabling of DBE, the UHR operation element may include a 2-bit or 3-bit DBE operating bandwidth indication in UHR Operation element, one-bit Disable Subchannel Bitmap Present field indication about whether the DBE static channel puncture pattern exists in UHR Operation element, and 2-octet Punctured Subchannel Bitmap in UHR Operation element which indicates the punctured 20 MHz channel(s) in a DBE operating bandwidth if the Disable Subchannel Bitmap Present field is equal to 1. The station 104 may receive the UHR Operation element and based on the DBE operation enabling/disabling announcement of the UHR operation element determine the AP's operating bandwidth, channel puncture etc. based on the DBE operating channel and DBE operating bandwidth.

In some embodiments, the station 104 may not receive a beacon including the UHR operational element, e.g., due to interference in a wireless channel. The AP 102 may use the UHR critical update procedure to announce the DBE's enabling, disabling, updating by transmitting a critical update element 122 in a management frame such as a beacon. The station 104 may receive the announcement about the DBE's enabling, disabling, updating in advance of the DBE's enabling, disabling, updating. When the DBE operation is enabled, the critical update element 122 may further include DBE information including one or more of the DBE operating bandwidth and a DBE static channel puncture pattern (2-octet Punctured Subchannel Bitmap) of the DBE operating bandwidth. The DBE operating bandwidth may be indicated by a 2-bit DBE operating bandwidth field which indicates the DBE operating bandwidth. In one embodiment, the DBE operating bandwidth may be one of 80 MHz, 160 MHz, 320 MHz-1, 320 MHz-2 (00 . . . 80 MHz, 01 . . . 160 MHz, 10 . . . 320 MHz-1, 11 . . . 320 MHz-2). In another embodiment, the bandwidth may be one of 160 MHz, 320 MHz-1, 320 MHz-2. The 320 MHz channel consists of any two adjacent 160 MHz channels in the 6 GHz band. 320 MHz-1 is defined as a 320 MHz channel with a channel center frequency numbered 31, 95, or 195 for 160 MHz channel segments while 320 MHz-2 is defined as a 320 MHz channel with a channel center frequency numbered 63, 127, or 191 for 160 MHz channel segments. In some embodiment, if the 320 MHz bandwidth is announced by one value instead of 320MHz-1, 320MHz-2, channel center frequency segment (CCFS) 0 and CCFS 1 as defined by an EHT Operation element, HE Operation element etc. may be used to define the channel center frequency of two segments of the DBE operating channel. Each CCFS may define a center frequency of a respective 160 MHz segment of the 320-1 or 320-2MHz DBE operating bandwidth so as to distinguish between 320-1 MHz and 320-2 MHz bandwidths. In an embodiment, the DBE operating bandwidth may be one of 80 MHz, 160 MHz, 320 MHz defined by a 2 bit DBE operating bandwidth field. Further, the punctured channels that is in the DBE static channel puncture pattern of the DBE operating channel and that are covered by the BSS operating channel are same as the punctured channels in the BSS static channel puncture pattern announced by the EHT Operation element. After the announcement that DBE is enabled, the AP 102 supporting DBE operation enables its DBE operation until the AP 102 disables the DBE operation. In an embodiment, the station 104 may then negotiate with the AP 102 to enable or disable its DBE operation. At some later time, the AP 102 supporting DBE operation disables its DBE operation by transmitting Critical Update element with DBE operation being indicated disabled.

In some embodiments, the DBE operation is only applicable in the periodic service periods (SPs) defined by one or multiple broadcast target wakeup time (TWT) schedules with each broadcast TWT schedule being indicated by a broadcast TWT identification (ID). The SP may be a negotiated time for the AP and station to transmit data. The AP 102 may be arranged to transmit the broadcast TWT agreements and transmit the DBE information to indicate that the enabled DBE will be applied in the broadcast TWT schedule(s). In such embodiments, outside the periodic SPs of the indicated broadcast TWT schedule(s), the DBE bandwidth, channel, DBE static channel puncture pattern are not be applied.

An AP 102 and station 104 may also perform a coordinated beamforming (CBF) compliant with Institute of Electrical and Electronics Engineers (IEEE) 802.11bn or Ultra High Reliability (UHR). Beamforming is a signal processing technique used in wireless communication and other systems to focus a transmitted signal in a specific direction, rather than broadcasting the transmitted signal in all directions. Transmissions of each of the antenna 106, 108 may be weighted to focus the transmitted signal in the specific direction and improve signal reception at a receiver. In an embodiment, if the AP's associated STA 104 when enabling DBE operation is able to use an entire DBE operating bandwidth, the AP 102 enabling its DBE operation announces the DBE operating bandwidth as the AP's operating bandwidth to another AP for CBF operation and the DBE static channel puncture pattern covering the DBE operating bandwidth to another AP for CBF operation. Otherwise, the AP 102 enabling its DBE operation announces its bandwidth for CBF operation as the BSS operating bandwidth and the channel puncture covering the BSS operating bandwidth.

One or more of the AP 102 and station 104 may support a non-primary channel access (NPCA) capability. NPCA allows a wireless device to transmit unicast data frames, some unicast management frames, and control frames on secondary 20 MHz channels when the primary channel is unavailable (e.g., due to overlapping BSS interference). In one or more embodiments, a NPCA primary channel may be covered by the BSS operating channel 126 or not covered by the BSS operating channel 126. The AP 102 may enable the NPCA before or after the AP 102 enables the DBE operation which then determines whether the associated station 104 may also be able to enable its NPCA based on whether the associated station 104 supports DBE operation.

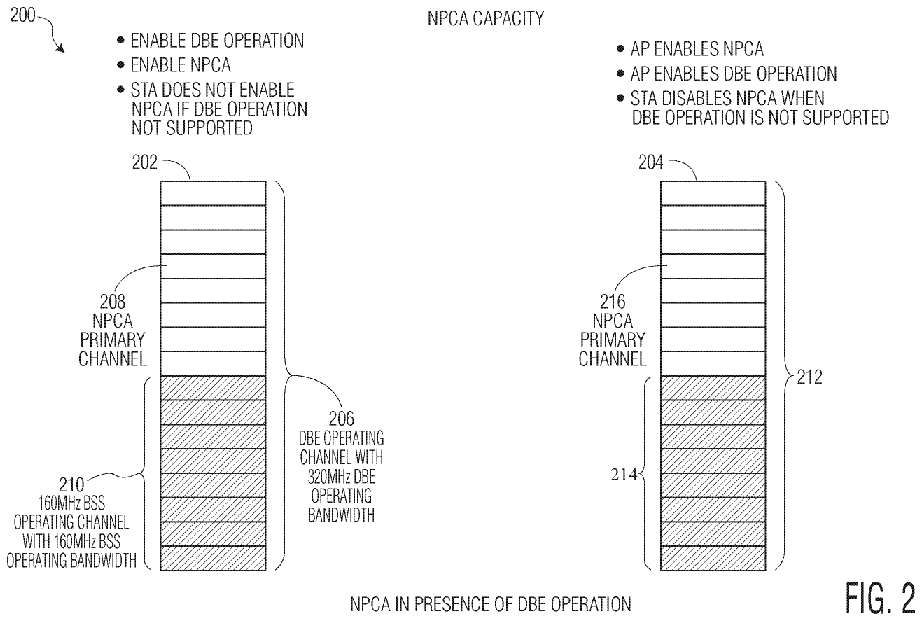

FIG. 2 illustrates example operating channels 200 and enabling of NPCA not covered by a BSS operating channel 210 when DBE operation is enabled by an AP 102 in accordance with one or more embodiments. In an embodiment shown by operating channels 202, the AP 102 may have the BSS operating channel 210 which includes 8 channels which are each 20 MHz to define a BSS operating bandwidth of 160 MHz. In one embodiment, the AP 102 may enable NPCA after enabling DBE operation. The BSS operating channel 210 may have an NPCA primacy channel 208 not covered by the BSS operating channel 210 and covered by a DBE operating channel 206. When the AP 102 announces its NPCA primary channel 208 being not covered by the AP's BSS operating channel 210, a station 104 that doesn't support DBE operation may not enable NPCA. In another embodiment shown by operating channels 204, the AP 102 may enable its NPCA and then enable its DBE operation. When the AP 102 announces its NPCA primary channel 216 being not covered by the AP's BSS operating channel 214 and covered by the DBE operating channel 212, a station 104 that enabled the NPCA and does not support DBE operation disables its NPCA. The disabling may be automatic when the DBE operation is enabled or the disabling is performed through an Action frame handshake. A variant to this is that an AP 102 enabling DBE operation is not allowed to have its NPCA primary channel being not covered by the AP's BSS operating channel if the AP 102 has an associated STA that enabled its NPCA and doesn't support DBE operation. In such case, the AP can disable its NPCA, enable DBE operation and enable NPCA with NPCA primary channel not being covered by the BSS operating channel. The station 104 that does not support DBE operation may not enable its NPCA. Such rules can also be applied to DSO (dynamic subband operation) where a station 104 can switch to its DSO subband not covering an AP's primary channel instead of the station 104 subband covering AP's primary channel within the station 104 bandwidth. When DBE is disabled or updated where the station 104 DSO subband is not covered by the AP's operating bandwidth (BSS operating bandwidth if the DBE is disabled or DBE bandwidth if the DBE is enabled/updated), the station 104 DSO operation is automatically disabled.

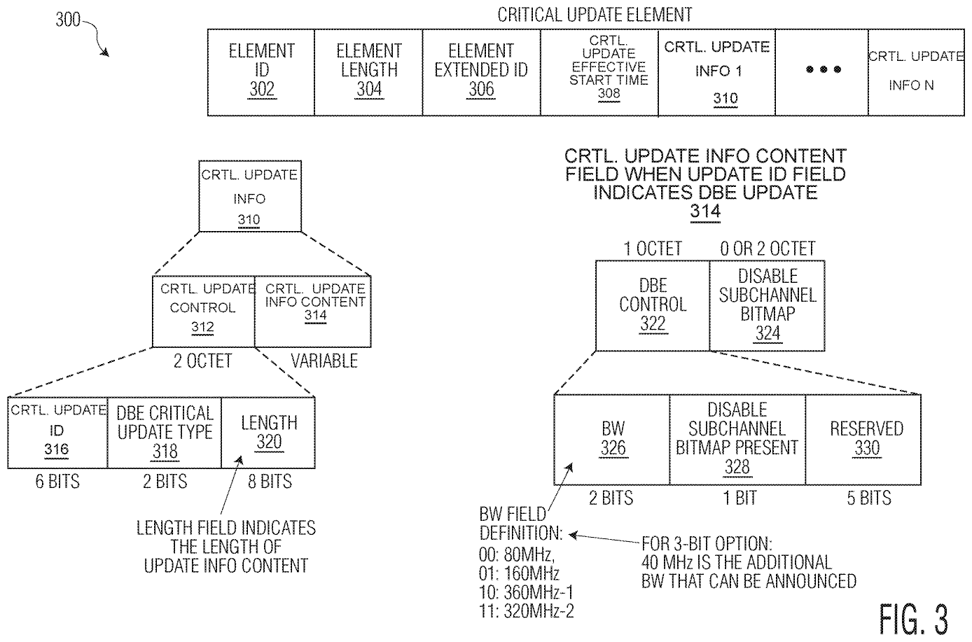

FIG. 3 illustrates an example fields of a critical update element 300 carrying DBE information in accordance with one or more embodiments. The critical update element 300 is carried in a beacon, (multilink) Probe Response etc. The AP 102 may indicate to enable or disable the DBE operation based on an indication in the critical update element 300. The critical update element 300 may have a plurality of fields. The fields include an element ID field 302 identifying the element as a critical update element, an element length field 304 indicating a length of the critical update element, an extended element identification field 306 to indicate extension of element identifications not able to be represented by the element identification field 302, a critical (CRTL) update effective start time field 308, and a plurality of critical update information subelements 310. In an embodiment, an element is a structured piece of data within management frames (like beacons or probe responses) used to communicate capabilities, configurations, or parameters between devices (STAs) while a subelement is a more granular data field nested within these larger information elements to provide specific, detailed information. The element generally consists of a 1-byte element ID, a 1-byte length field, and a variable-length information field while the subelement has its own ID, length, and data.

The critical update effective start time field 308 may indicate a time when the DBE operation is enabled, updated, or disabled. The critical update effective start time field 308 may have a same definition as a mapping start time field of a traffic identifier (TID) to link mapping element. In some embodiments, the start time may be defined by a remaining time (e.g., number of beacons) before a target beacon transmit time (TBTT) of a beacon when the AP enables, updates, or disables the DBE. The critical update effective start time field 308 in each beacon preceding the TBTT may indicate a count down to the TBTT when the AP enables or disables the DBE. The critical update information subelement 310 may indicate the DBE information. The critical update information subelement 310 may have a critical update control field 312 and a critical update info content field 314. The Critical Update control field 312 may have an update identification field 316, a DBE critical update type field 318, and a length field 320. The critical update identification field 316 may indicate the type of critical update, e.g. enabling or disabling of a DSO (Dynamic Subband Operation) which allows the Access Point (AP) to use a specific subband (e.g., 160 MHz within a wider channel) to improve efficiency, enabling or disabling of a DUO (Dynamic Unavailability Operation/Mode) which is a coexistence mechanism that manages times when a device is unavailable, enabling or disabling of a DPS (Dynamic Power Save/Saving) which allows for improved power efficiency, where devices may operate in a lower capability mode (LC) to save power and transition to higher capability (HC) when needed, enabling or disabling of a NPCA (Non-Primary Channel Access) which is a mechanism that allows devices to transmit on channels other than the primary channel, and the DBE operation. The DBE critical update type field 318 may indicate a type of the update such as enable, updates, or disable of the DBE operation. A length field 320 may indicate a length of the update information field. The Critical Update info content field 314 may indicate for a DBE critical update a DBE control field 322 and a disabled subchannel bitmap field 324 (e.g., a puncture pattern for the DBE operating bandwidth). The DBE control field 322 may further define a bandwidth field 326 which indicated a DBE operating bandwidth, a disabled subchannel bitmap present field 328 which indicates whether a disabled subchannel bitmap for the DBE operating bandwidth exists or not, and a reserved field 330. The bandwidth field 326 may be two or three bits. If the bandwidth field is two bits, then 00 may indicate a 80 MHz bandwidth, 01 may indicate a 160 MHz bandwidth, 10 may indicate a 320-1 MHz bandwidth, and 11 may indicate a 320-2 MHz bandwidth. If the bandwidth field 326 is three bits, one of a three bit pattern may identify a 40 MHz bandwidth option.

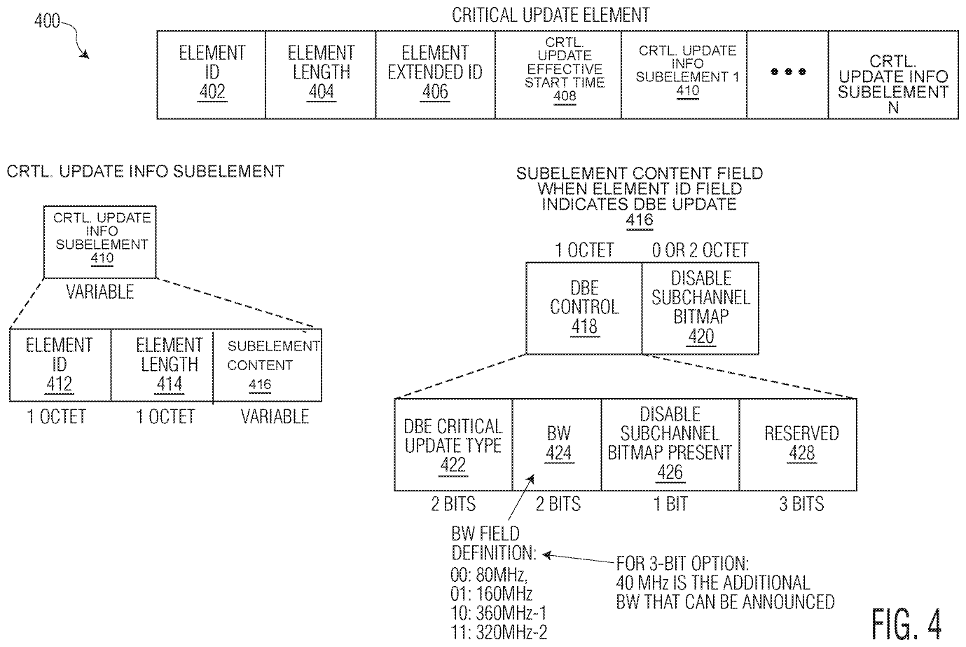

FIG. 4 illustrates another example fields of a critical update element 400 carrying DBE information in accordance with one or more embodiments. The critical update element 400 of a beacon carries DBE information. The critical update element 400 may include an element identification field 402, an element length field 404, an element extension identification field 406, a critical update effective start time field 408, and a plurality of critical update information subelements 410. In an embodiment, the critical update information subelement 410 may include an element identification field 412, an element length field 414, and a subelement content field 416. The element identification field 412 may indicate the critical update information subelement 410 has DBE information and the element length field 414 may indicate a length of the critical update information subelement 410. The subelement content field 416 may have a DBE control field 418 when the element ID field indicates DBE information. The DBE control field 418 may further include a DBE critical update type field 422 to indicate whether the DBE is enabled or disabled, a bandwidth field 424 which indicates a DBE operating bandwidth, a disabled subchannel bitmap present field 426 which indicates whether a disabled subchannel bitmap field 420 is included which indicates a DBE static puncture channel pattern for the DBE operating bandwidth, and a reserved field 428. If the bandwidth field is two bits, then 00 may indicate a 80 MHz bandwidth, 01 may indicate a 160 MHz bandwidth, 10 may indicate a 320-1 MHz bandwidth, and 11 may indicate a 320-2 MHz bandwidth. If the bandwidth field is three bits, one of a three bit pattern may identify a 40 MHz bandwidth option.

In one or more embodiments, the station 104 associated with the AP 102 receives the indication that the AP 102 enables the DBE operation. In some embodiments, in response, a STA supporting DBE can use the DBE bandwidth, DBE channel, DBE static channel pattern. In some embodiment, in response, the station 104 which supports DBE operation may enable or disable DBE operation with the AP 102 by a negotiation.

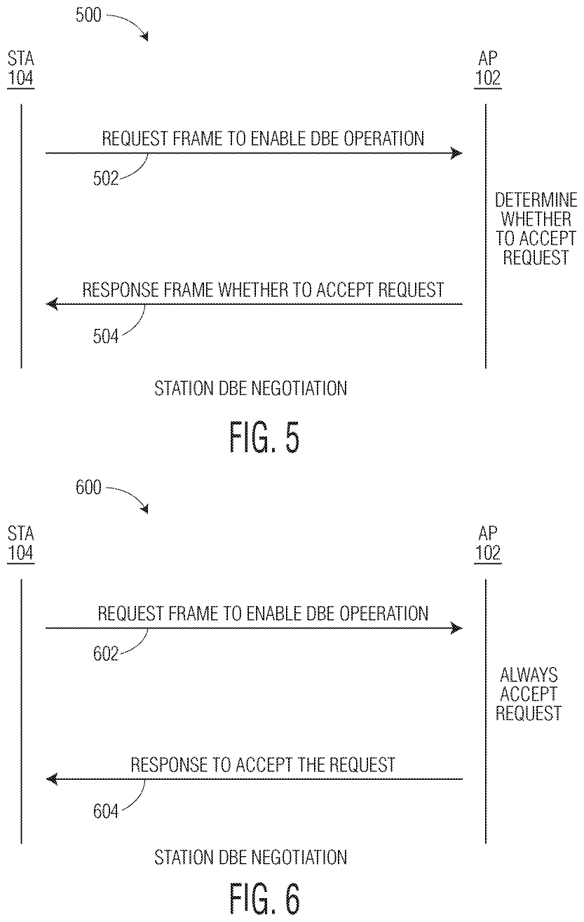

FIG. 5 illustrates an example negotiation 500 between the station 104 and AP 102 to enable the DBE operation by the station and the AP in accordance with one or more embodiments. The negotiation may begin with the station 104 sending a request frame 502 to the AP 102 to enable the DBE operation. The AP 102 may receive the request frame 502 and determine whether to accept the request to enable the DBE operation and send a response frame 504 to the station 104 to indicate whether or not the request is accepted. In an embodiment, the AP 102 may selectively control nearby associated stations to use a wider DBE operating bandwidth while far away associated stations may use the narrower BSS operating bandwidth to improve throughput based on the request that is sent to a particular station 104. In an embodiment, the response by the AP 102 to far stations may indicate to not enable DBE operation while the response by the AP 102 to near stations may be to enable DBE operation.

FIG. 6 illustrates another example negotiation 600 between the station 104 and AP 102 to enable the DBE by the station and the AP in accordance with one or more embodiments. The AP 102 may announce the DBE operation is enabled. The station 104 may then send a request frame 602 to the AP 102 to enable its DBE operation. The AP 102 may always accept the request if the AP 102 enables DBE.

In some embodiments, a station 104 that supports DBE operation may enable its DBE operation automatically. If the associated AP 102 to the station 102 announces the enablement of the DBE operation and a supported bandwidth of the station 104 is wider than the BSS operating bandwidth, the station 104 may responsively enable the DBE operation without further signaling. Otherwise, the station 104 may not enable the DBE operation.

The request to enable DBE operation transmitted by the station 104 and response transmitted by the AP 102 may take the form of a UHR feature request and UHR feature response action frame. In one embodiment, the AP 102 may always accept the request from the station 104 by sending a response frame.

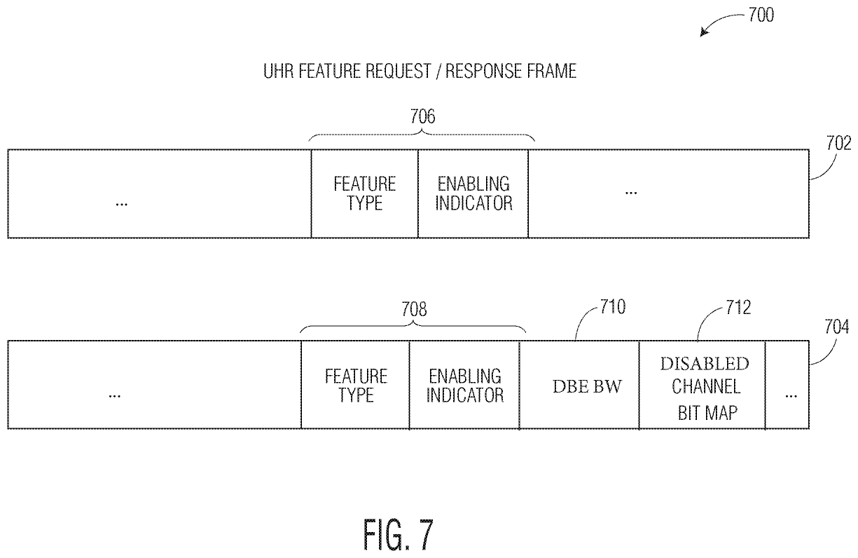

FIG. 7 illustrates example fields 700 of the UHR request frame 702 and UHR response frame 704 associated with the negotiation of DBE operation by the AP 102 and station 104 in accordance with one or more embodiments. The request frame 702 may be a UHR feature request action frame transmitted by the station 104 and the response frame 704 may be a UHR feature response action frame transmitted by the AP 102 during negotiation of the DBE operation. The frames 702, 704 may be the Action frames. In one embodiment, an action field 706 in the request frame 702 may define a feature type and an enabling indication. The feature type may indicate one of DBE operation, NPCA, DPS, DSO, and DUO while the enabling indication may indicate a request by the station 104 to enable or disable DBE operation. An action field 708 in the response frame 704 may indicate a feature type while an enabling indication may indicate whether the station 104 is to enable or disable the DBE operation as a response by the AP 102 to the request. In some embodiments, the UHR response frame 704 may also carry an indication of the DBE operating bandwidth 710 and the disabled subchannel bitmap 712 of the STA 104 when DBE operation is enabled.

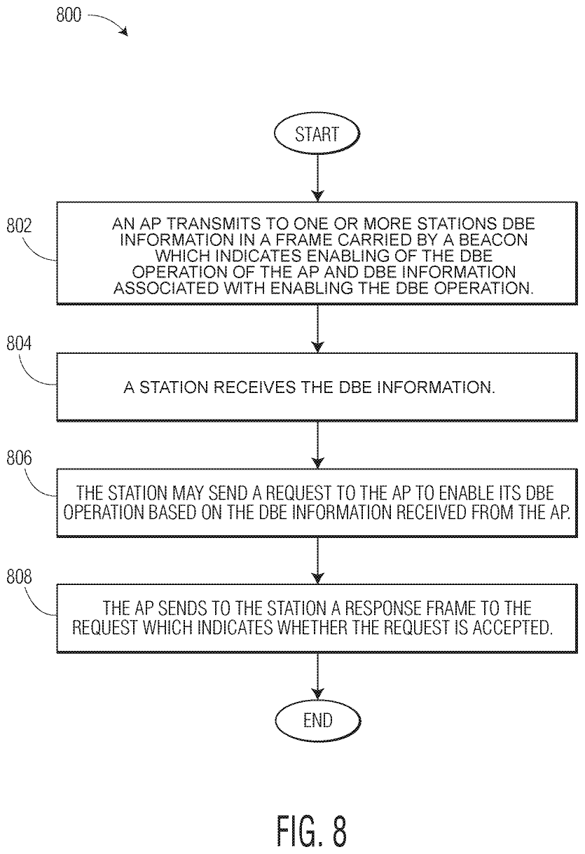

FIG. 8 is an example flowchart 800 of functions associated with dynamic bandwidth extension (DBE) configuration of the AP and one or more stations in accordance with one or more embodiments. The functions may be performed by the AP 102 and station 104 and in an embodiment based on the AP 102 announcing a DBE capability.

At 802, an AP transmits to one or more stations DBE information carried by a frame in a beacon which indicates enabling of the DBE operation of the AP and DBE information associated with enabling the DBE operation. The DBE information may include one or more of a DBE operating bandwidth and a disabled subchannel bitmap which indicates punctured channels in a DBE operating channel. The DBE information may be carried in a UHR operation element or a critical update element of the beacon in an embodiment. At 804, a station of the one or more stations receives the frame having the DBE information. At 806, the station may send a request to the AP to enable its DBE operation based on the DBE information received from the AP. At 808, the AP sends to the station a response frame to the request which indicates whether the request is accepted. In some embodiments, the AP may always accept the request with or without further signaling.

In one embodiment, a method for performing dynamic bandwidth extension (DBE) between an access point (AP) and a station (STA) operating in accordance with Institute of Electrical and Electronics Engineers (IEEE) 802.11bn is disclosed. The method comprises: transmitting, by the AP, a frame which indicates that the AP enables DBE operation, the frame defining DBE information which indicates when the DBE operation is enabled; receiving, by the station, the frame; transmitting, by the station, a request to the AP to enable the DBE operation on the station; receiving, by the AP, the request from the station; determining, by the AP, whether to accept the request to enable the DBE operation by the station; and transmitting, by the AP, a response to the request of whether to enable the DBE operation to the station. In an embodiment, the DBE information includes an indication of a DBE operating bandwidth and an indication of whether a disabled channel bitmap is present. In an embodiment, the DBE operating bandwidth is indicated by two bits and is one of 80 MHz, 160 MHz, 320 MHz-1, 320 MHz-2 and the disabled channel bitmap is a two-octet punctured subchannel bitmap. In an embodiment, if the indication indicates the disabled channel bitmap is present, the DBE information includes the disabled channel bitmap, otherwise the DBE information does not include the disabled channel bitmap. In an embodiment, the frame is a management frame having a Critical Update Element or Operation Element defined by IEEE 802.11bn. In an embodiment, the AP always accepts the request by the station to enable the DBE operation. In an embodiment, the DBE information indicates that the DBE operation of the AP is enabled or disabled. In an embodiment, a critical update information field of a critical update element of the frame indicates the DBE information. In an embodiment, the request and response are ultra high reliability (UHR) Feature Action frames. In an embodiment, the request indicates a feature type field indicating a DBE operation type and an enabling indication which indicates a request to enable the DBE operation of the station. In an embodiment, the response indicates a feature type field indicating a DBE operation type and an enabling indication which indicates the DBE operation of the station is to be enabled. In an embodiment, the response further includes a disabled subchannel bitmap of the station. In an embodiment, a critical update effective start time field of a critical update element of the frame indicates a remaining number of beacons transmitted before a target beacon transmit time (TBTT) when the DBE operation of the AP is enabled. In an embodiment, the AP that enables the DBE operation is allowed to only change its operating bandwidth by a DBE update procedure.

In another embodiment, an access point (AP) configured to perform dynamic bandwidth extension (DBE) between the access point and a station (STA) operating in accordance with Institute of Electrical and Electronics Engineers (IEEE) 802.11bn is disclosed. The AP is configured to transmit, by the AP, a frame which indicates that the AP is enabling DBE operation, the frame defining DBE information which indicates when the DBE operation is enabled; receive a request to the AP to enable DBE operation by the station; determine whether to accept the request to enable the DBE operation by the station; and transmit a response to the request whether to enable the DBE operation. In an embodiment, the DBE information includes an indication of a DBE operating bandwidth and an indication of whether a disabled channel bitmap is present. In an embodiment, a DBE operating bandwidth is indicated by two bits and is one of 80 MHz, 160 MHz, 320 MHz-1, 320 MHz-2 and the disabled channel bitmap is a two-octet punctured subchannel bitmap. In an embodiment, if the indication indicates the disabled channel bitmap is present, the DBE information includes the disabled channel bitmap, otherwise the DBE information does not include the disabled channel bitmap. In an embodiment, the frame is a management frame having a Critical Update Element or Operation Element defined by IEEE 802.11be (UHR). In an embodiment, an update effective start time field of a critical update element of the frame indicates a remaining number of beacons transmitted before a target beacon transmit time which indicates the DBE operation of the AP is enabled.

A few implementations have been described in detail above, and various modifications are possible. The disclosed subject matter, including the functional requests described in this specification, can be implemented in electronic circuit, computer hardware, firmware, software, or in combinations of them, such as the structural means disclosed in this specification and structural equivalents thereof: including potentially a program operable to cause one or more content processing apparatus such as a processor to perform the requests described (such as a program encoded in a non-transitory computer-readable communication medium, which can be a memory device, a storage device, a machine-readable storage substrate, or other physical, machine readable communication medium, or a combination of one or more of them).

While this specification contains many specifics, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while requests are depicted in the drawings in a particular order, this should not be understood as requiring that such requests be performed in the particular order shown or in sequential order, or that all illustrated requests be performed, to achieve desirable results. In certain circumstances, multitasking and parallel processing may be advantageous. Moreover, the separation of various system components in the implementations described above should not be understood as requiring such separation in all implementations.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed. Other implementations fall within the scope of the following claims.

What is claimed is:

1. A method for performing dynamic bandwidth extension (DBE) between an access point (AP) and a station (STA) operating in accordance with Institute of Electrical and Electronics Engineers (IEEE) 802.11bn, the method comprising:
transmitting, by the AP, a frame which indicates that the AP enables DBE operation, the frame defining DBE information which indicates when the DBE operation is enabled;
receiving, by the station, the frame;
transmitting, by the station, a request to the AP to enable the DBE operation on the station;
receiving, by the AP, the request from the station;
determining, by the AP, whether to accept the request to enable the DBE operation by the station; and
transmitting, by the AP, a response to the request of whether to enable the DBE operation to the station.

2. The method of claim 1, wherein the DBE information includes an indication of a DBE operating bandwidth and an indication of whether a disabled channel bitmap is present.

3. The method of claim 2, wherein the DBE operating bandwidth is indicated by two bits and is one of 80 MHz, 160 MHz, 320 MHz-1, 320 MHz-2 and the disabled channel bitmap is a two-octet punctured subchannel bitmap.

4. The method of claim 2, wherein if the indication indicates the disabled channel bitmap is present, the DBE information includes the disabled channel bitmap, otherwise the DBE information does not include the disabled channel bitmap.

5. The method of claim 1, wherein the frame is a management frame having a Critical Update Element or Operation Element defined by IEEE 802.11bn.

6. The method of claim 1, wherein the AP always accepts the request by the station to enable the DBE operation.

7. The method of claim 1, wherein the DBE information indicates that the DBE operation of the AP is enabled or disabled.

8. The method of claim 1, wherein a critical update information field of a critical update element of the frame indicates the DBE information.

9. The method of claim 1, wherein the request and response are ultra high reliability (UHR) Feature Action frames.

10. The method of claim 9, wherein the request indicates a feature type field indicating a DBE operation type and an enabling indication which indicates a request to enable the DBE operation of the station.

11. The method of claim 9, wherein the response indicates a feature type field indicating a DBE operation type and an enabling indication which indicates the DBE operation of the station is to be enabled.

12. The method of claim 11, wherein the response further includes a disabled subchannel bitmap of the station.

13. The method of claim 1, wherein a critical update effective start time field of a critical update element of the frame indicates a remaining number of beacons transmitted before a target beacon transmit time (TBTT) when the DBE operation of the AP is enabled.

14. The method of claim 1, wherein the AP that enables the DBE operation is allowed to only change its operating bandwidth by a DBE update procedure.

15. An access point (AP) configured to perform dynamic bandwidth extension (DBE) between the access point and a station (STA) operating in accordance with Institute of Electrical and Electronics Engineers (IEEE) 802.11bn by transmitting, by the AP, a frame which indicates that the AP is enabling DBE operation, the frame defining DBE information which indicates when the DBE operation is enabled; receiving a request to the AP to enable DBE operation by the station; determining whether to accept the request to enable the DBE operation by the station; and transmitting a response to the request whether to enable the DBE operation.

16. The AP of claim 15, wherein the DBE information includes an indication of a DBE operating bandwidth and an indication of whether a disabled channel bitmap is present.

17. The AP of claim 16, wherein DBE operating bandwidth is indicated by two bits and is one of 80 MHz, 160 MHz, 320 MHz-1, 320 MHz-2 and the disabled channel bitmap is a two-octet punctured subchannel bitmap.

18. The AP of claim 16, wherein if the indication indicates the disabled channel bitmap is present, the DBE information includes the disabled channel bitmap, otherwise the DBE information does not include the disabled channel bitmap.

19. The AP of claim 15, wherein the frame is a management frame having a Critical Update Element or Operation Element defined by IEEE 802.11be (UHR).

20. The AP of claim 15, wherein an update effective start time field of a critical update element of the frame indicates a remaining number of beacons transmitted before a target beacon transmit time which indicates the DBE operation of the AP is enabled.
